(19) United States
(12) Patent Application Publication
(10) Pub. No.: US 2013/0292950 A1
(43) Pub. Date: Nov. 7, 2013

(54) WIND TURBINE

(71) Applicants: Siemens Aktiengesellschaft, Munich (DE); Nordex Energy GmbH, Rostock (DE)

(72) Inventors: Uwe Ritschel, Zweedorf (DE); Robert Gutzmer, Rostock (DE); Ulrich Hartmann, Berlin (DE); Andreas Joeckel, Nuernberg (DE); Gunther Elender, Fuerstenzell (DE); Axel Moehle, Berlin (DE)

(21) Appl. No.: 13/936,095

(22) Filed: Jul. 5, 2013

Related U.S. Application Data
(63) Continuation of application No. PCT/EP2011/073773, filed on Dec. 22, 2011.

(30) Foreign Application Priority Data
Jan. 5, 2011 (DE) 10 2011 008 029.5

(51) Int. Cl. F03D 9/00

(52) U.S. Cl. CPC F03D 9/002
USPC 290/55

(57) ABSTRACT

A wind turbine includes a machine frame (20) and, on opposite sides of the machine frame (20), a rotor and a generator (10). The rotor and the generator (10) are coupled to one another, without a gearbox, via a rotor shaft (60) and a generator shaft (70) an interposed coupling arrangement (50). The generator (10) has an external rotor configuration.

### CROSS REFERENCE TO RELATED APPLICATIONS

This application is a continuation application of international patent application PCT/EP2011/073773, filed Dec. 22, 2011, designating the United States and claiming priority from German application 10 2011 008 029.5, filed Jan. 5, 2011, and the entire content of both applications is incorporated herein by reference.

### BACKGROUND OF THE INVENTION

U.S. Pat. No. 6,911,741 discloses a wind turbine which has, in a machine frame, a double-mounted rotor shaft and a generator shaft, which is formed integrally with the rotor shaft or is rigidly connected thereto with the result that both shafts follow a common bending movement under the effect of bending torques. The generator has an internal-rotor configuration, wherein the generator stator and the generator rotor are mounted on the rotatable rotor and generator shaft in such a manner that the generator can follow bending movements of the drive shaft. A non-rotatable coupling arrangement fixes the generator stator against rotational movements to the machine frame and enables the generator to follow the bending movements of the input shaft relative to the machine frame, as a result of which a constant air gap between the generator rotor and the generator stator is provided. Such a configuration and manner of fastening the generator is very complex in design terms, which can result in a high weight of the wind turbine in relation to the power produced.

### SUMMARY OF THE INVENTION

At least one object of specific embodiments is to provide a wind turbine enabling a simpler design.

The wind turbine of the invention includes: a machine frame having a first side and a second side; a rotor disposed on the first side of the machine frame; a generator disposed on the second side of the machine frame; a rotor shaft; a generator shaft; a coupling arrangement disposed between the rotor shaft and the generator shaft; the generator and the rotor being gearlessly coupled to one another via the rotor shaft, the generator shaft and the coupling arrangement; and, the generator having an external rotor configuration.

In accordance with at least one embodiment, a wind turbine comprises a machine frame. The machine frame can be arranged in particular so as to be mounted rotatably onto a tower.

According to a further embodiment, the wind turbine comprises a rotor. The rotor, which can be mounted on the machine frame rotatably about a rotor hub, serves to convert the kinetic energy of the wind into rotational energy and transmitting it to a generator at least via one rotor shaft. Furthermore, the wind turbine comprises a generator, arranged to receive the rotational energy via a generator shaft and to convert it into electrical energy.

According to a further embodiment, the rotor and the generator are arranged on opposite sides of the machine frame, which, for example, has the advantage of improved weight distribution of the masses of the machine frame, the rotor and the generator in comparison with wind turbines in which the generator is arranged between the tower or machine frame and the rotor. This improved distribution of the tower head mass results in reduced material stress and in a reduced complexity in terms of maintenance and higher availability of the wind turbine. Furthermore, as a result, a higher degree of modularity of the wind turbine and therefore a reduced amount of complexity in terms of maintenance and/or repair work is achieved because, for example, the generator can be removed from the turbine without dismantling the rotor.

According to a further embodiment, the wind turbine comprises a coupling arrangement, which is arranged between the rotor shaft and the generator shaft and which couples the rotor shaft and the generator shaft to one another, with the result that the rotary movement Of the rotor shaft can be transmitted to the generator shaft. Particularly preferably, the rotor shaft and the generator shaft are gearlessly coupled to one another by means of the coupling arrangement. In other words, a rotary movement of the rotor shaft can thus be transmitted directly to the generator shaft without an interposed gearbox.

In comparison to known wind turbines comprising an interposed gearbox, there is thus advantageously no longer the complexity involved with the gearbox in terms of maintenance and repair work or any need for a replacement of the gearbox as a result of wear on the gearbox over the life cycle of the wind turbine.

According to a further embodiment, the generator has an external-rotor configuration. As such the generator comprises a generator stator and a generator rotor, which encloses the generator stator on the outside and is arranged rotatably about the generator stator. In comparison to known wind turbines comprising generators with an internal-rotor configuration, it may advantageously be possible to achieve a higher generator power output at virtually the same weight, which can result in more economical operation.

According to a further preferred embodiment, the coupling arrangement transmits rotary movements of the rotor shaft to the generator shaft, while the generator shaft is at least partially decoupled from bending movements of the rotor shaft by means of the coupling arrangement. Such bending movements can be brought about by forces which, for example, occur at the rotor or the rotor hub as a result of different wind conditions at the rotor blades. For permanent operation, it is essential to ensure that the bending movements are not transmitted to the generator in such a manner that the distance or air gab between the exciter and the induction coils of the generator, which are arranged on the generator rotor and on the generator stator, is changed. Because of the at least partial mechanical decoupling of the rotor shaft from the generator shaft, which can, for example, be achieved as a result of a flexibility of the coupling arrangement in one or more planes parallel to the axes of the rotor shaft and the generator shaft, it is advantageously possible for transmission of bending movements from the rotor shaft to the generator shaft to be reduced or prevented entirely. For the coupling arrangement can allow tilting and/or shifting of the axis of the rotor shaft relative to the axis of the generator shaft.

Particularly preferably, the coupling arrangement is formed in such a manner that substantially, that is predominantly, only rotary movements about the axis of the rotor shaft are transmitted to the generator shaft, while bending movements of the rotor shaft are not transmitted to the generator shaft, or only to a very small extent.

According to a further preferred embodiment, the generator shaft is fastened to a rear side of the generator, the rear side facing away from the rotor, via a connection, preferably a flange connection or a welded joint.

Furthermore, the generator shaft can be borne substantially by the generator as a result of the connection to the rear side of the generator. In other words, the generator shaft can be supported on the rear side of the generator in such a way that no further elements need to be provided for mounting or fastening the generator shaft. In particular, it may be possible for the coupling arrangement essentially not to provide any bearing effect on the generator shaft and only to prevent the generator shaft from bending under its own weight. In comparison, known wind turbines often have generator shafts which at least partially bear the generator and on which the generator is at least partially supported. In this case, the generator shaft is required to be supported in a stable manner, for example on the machine frame, and needs to be mounted so as to be suitable for large loads.

In particular, the generator shaft can be directly connected to the coupling arrangement and the connection on the rear side of the generator and can protrude therebetween, without any physical contact, from the coupling arrangement through the generator or through the generator and part of the machine frame as far as to the rear side of the generator. Advantageously, a gap can be provided between the generator shaft and the generator or between the generator shaft and the machine frame, with the result that the generator shaft can move free of physical contact within the gap relative to the machine frame.

Furthermore, the generator shaft can be provided as a hollow shaft. This can be possible in particular due to the generator shaft not having a load-bearing function in the wind turbine, as a result of which the dimensioning of the generator shaft can be weight-optimized. Thus, for example, a ratio of the outer dimensions such as length and/or diameter of the generator shaft to its wall thickness can be such that the generator shaft does not bend under its own weight and for example also under the weight of service personnel. In particular, the ratio of the diameter to the wall thickness can be greater than or equal to 10:1, preferably greater than or equal to 20:1 and particularly preferably greater than or equal to 100:1. If the generator shaft has, for example, a diameter of approximately 2 m, the wall thickness can be much smaller and particularly preferably can be in the range of from greater than or equal to 2 cm and less than or equal to 5 cm.

In accordance with a further embodiment, the wind turbine is configured as a gearless, directly driven wind turbine, in which the generator is arranged on the opposite side of the rotor hub or the rotor with respect to the tower and/or the machine frame and in which the generator has an external-rotor configuration. Furthermore, the transmission of bending torques from the rotor shaft to the generator shaft can largely be avoided.

### BRIEF DESCRIPTION OF THE DRAWINGS

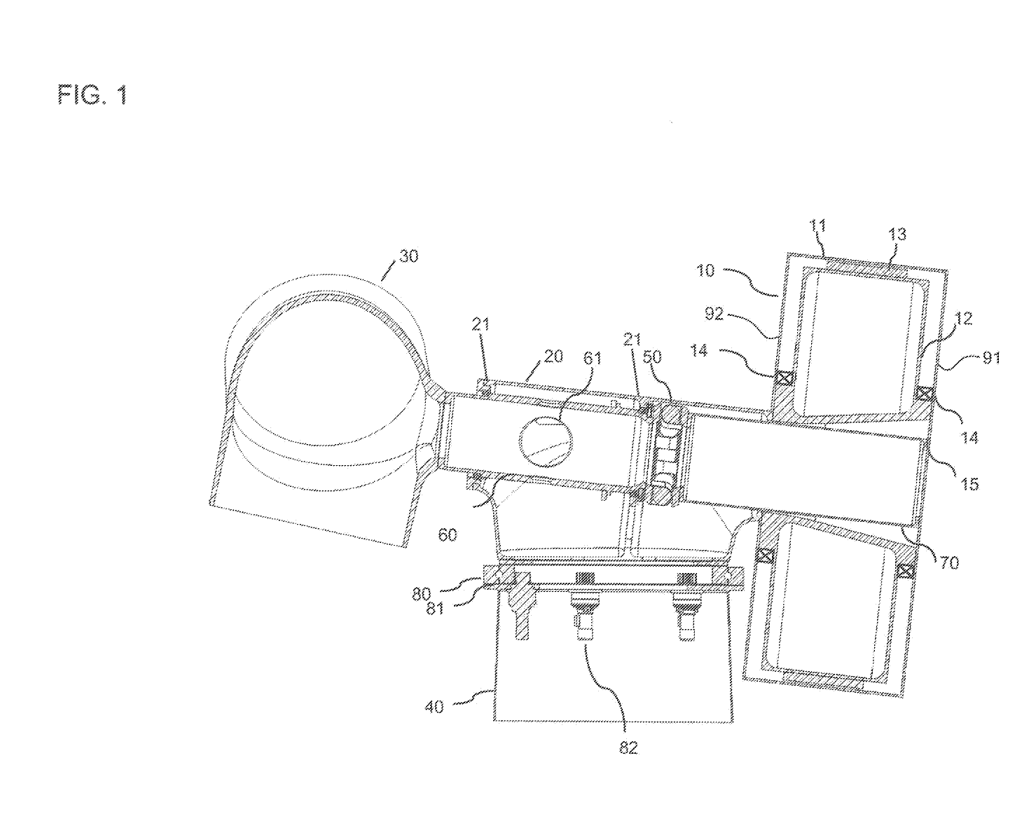

The invention will now be described with reference to the drawings wherein FIGS. 1 to 3 show schematic sectional views of wind turbines in accordance with embodiments of the invention.

### DESCRIPTION OF THE PREFERRED EMBODIMENTS OF THE INVENTION

Identical or functionally identical components can each be provided with the same reference symbols in the exemplary embodiments and figures. The elements shown and the size relationships of these elements with respect to one another cannot in principle be considered to be true to scale; individual elements may be shown as excessively thick or with excessively large dimensions to facilitate understanding of the invention.

The description below, where no explicit reference is mentioned, relates to all of FIGS. 1 to 3.

FIGS. 1 to 3 show exemplary embodiments of in each case a wind turbine which is configured as a directly driven wind turbine with a drive train which has a modular design and in which the generator is arranged on the opposite side of the rotor hub with respect to the tower.

The wind turbine comprises at least one generator 10 and a rotor hub 30 of a rotor with at least one or more rotor blades (not shown), provided about a machine frame 20.

Furthermore, the wind turbine comprises a tower 40, on top of which the machine frame 20 is arranged in a rotatable manner. The machine frame 20 is mounted rotatably with respect to the tower 40 by means of a yaw arrangement 80 comprising a yaw bearing 81, with the result that the rotor huh 30 with the rotor blades fastened thereon can be adjusted to track, in terms of its horizontal orientation, the wind direction using at least one yaw drive 82, which engages in a gearing provided on the yaw bearing 81. Optionally, the machine frame 20 can be screwed to the outer or inner ring of the yaw bearing 81.

The rotor hub 30 is fastened to a rotor shaft 60 in the form of a hollow shaft and is mounted rotatably in at least one bearing 21, 22, 23 with respect to the machine frame 20.

Furthermore, the wind turbine comprises a generator shaft 70 formed as a hollow shaft and a coupling arrangement 50, via which the rotor shaft 60 and the generator shaft 70 are connected to one another.

The generator 10 has an external-rotor configuration with an external generator rotor 11 and an inner generator stator 12.

The generator stator 12 is rigidly connected to the machine frame 20. Particularly preferably, the generator stator 12 and therefore the generator 10 is connected via a flange connection.

The generator rotor 11 is mounted rotatably on the generator stator 12 via bearings 14, which are arranged between the generator stator 12 and the generator rotor 11. As shown in the figures, the generator stator 12 comprises an outer wall and the generator rotor 11 comprises an inner wall, between which two bearings 14 are arranged in such a manner that the generator stator 12 is arranged between the bearings 14 with respect to an axis of rotation of the generator rotor 11. For this purpose, the generator stator 12 is particularly preferably intended to accommodate two bearings 14, whose inner bearing rings are fastened to the generator stator 12 and whose outer bearing rings are fastened to the generator rotor 11 in such a manner that the generator rotor 11 is mounted rotatably with respect to the generator stator 12. Particularly preferably, the two bearings 14 are provided as the only bearings on the generator side, that is on that side of the coupling arrangement 50 which faces the generator 10.

Furthermore, the generator rotor 11 comprises a rear side 91, which faces away from the machine frame 20, a lateral surface side, and a front side 92 facing the machine frame 20 and having an opening, wherein the generator rotor 11 surrounds the generator stator on all sides apart from the opening. The opening has a diameter which is less than or equal to an outer diameter of a bearing 14 arranged at the opening between the generator stator 12 and the generator rotor 11.

The generator shaft 70 is connected to the generator rotor 11 of the generator 10 on that side which is opposite or faces away from the machine frame 20, that is the rear side of the generator 10 a connection 15 in such a manner that the generator shaft 70 is substantially supported in the bearings 14 on the generator stator 12. The connection 15 is, for example, a flange connection or a welded joint.

The coupling arrangement 50 is substantial torsionally rigid and relatively soft axial and radial, with the result that essentially only torques are transmitted from rotor shaft 60 to the generator shaft 70. The coupling arrangement 50 can, for example, be provided in the form of an elastomer hydraulic coupling arrangement.

The rotor shaft 60 at generator shaft 70 are preferably designed to have a large shaft diameter and small wall thicknesses, for reasons of mass and servicing. In a preferred embodiment, the diameter of the rotor shaft 60 and the generator shaft 70 is, for example, 2 m.

The rotor shaft 60 can preferably have at least one radial opening 61, which can act as an access to the rotor hub for maintenance purposes. The generator shaft 70 can also be accessed from the rotor shaft 60 via the coupling arrangement 50.

The surrounding region of the at least one opening 61 of the rotor shaft 60 can be provided with stiffening elements 62.

Furthermore, the rotor shaft 60 preferably has a flange for fastening a slip ring (not shown), via which power can be supplied to electrical components located in the rotor hub 30, such as the rotor blade pitch drive (not shown), and communication with such components can established.

A further flange (not shown) in the region of the rotor shaft 60 facing the rotor hub 30 can be used to accommodate a rotor lock system for locking the rotor hub 30 and the rotor shaft 60 against the machine frame 20.

A further flange (not shown) in the region of the rotor shaft 60 facing the coupling arrangement 50 can be used to accommodate a holding brake for braking the rotor hub 30 and the rotor shaft 60 against the machine frame 20.

In order to optimally mechanically connect the rotor hub 30 and the generator 10, the machine frame 20 can be provided in the form of a truncated cone in the lower region (vertically) and in tubular form in the upper region (aligned substantially along the axis of the rotor shaft 20 and/or the generator shaft 70). As a result, the machine frame 20 can be provided in the form of a flange on the generator side to allow for a screw connection of the generator 10. On the hub side, the machine frame 20 can be provided tubular in the form of a conventional bearing seat or in the form of a flange for bearings which can be screwed on.

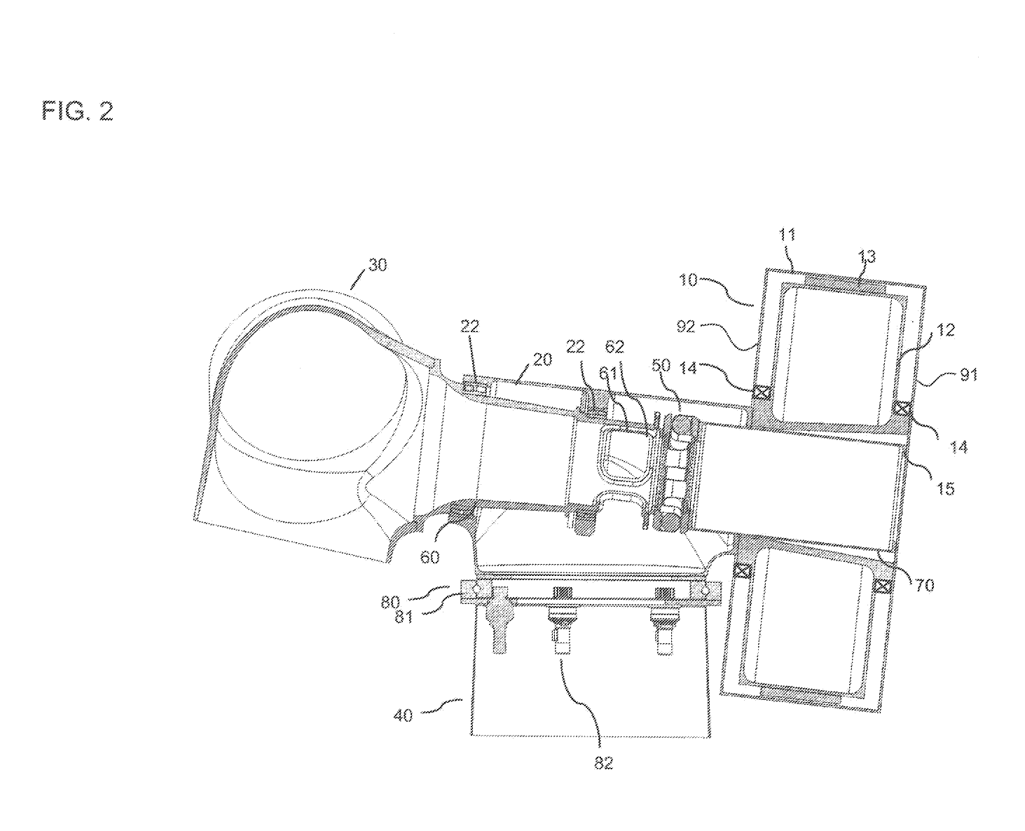

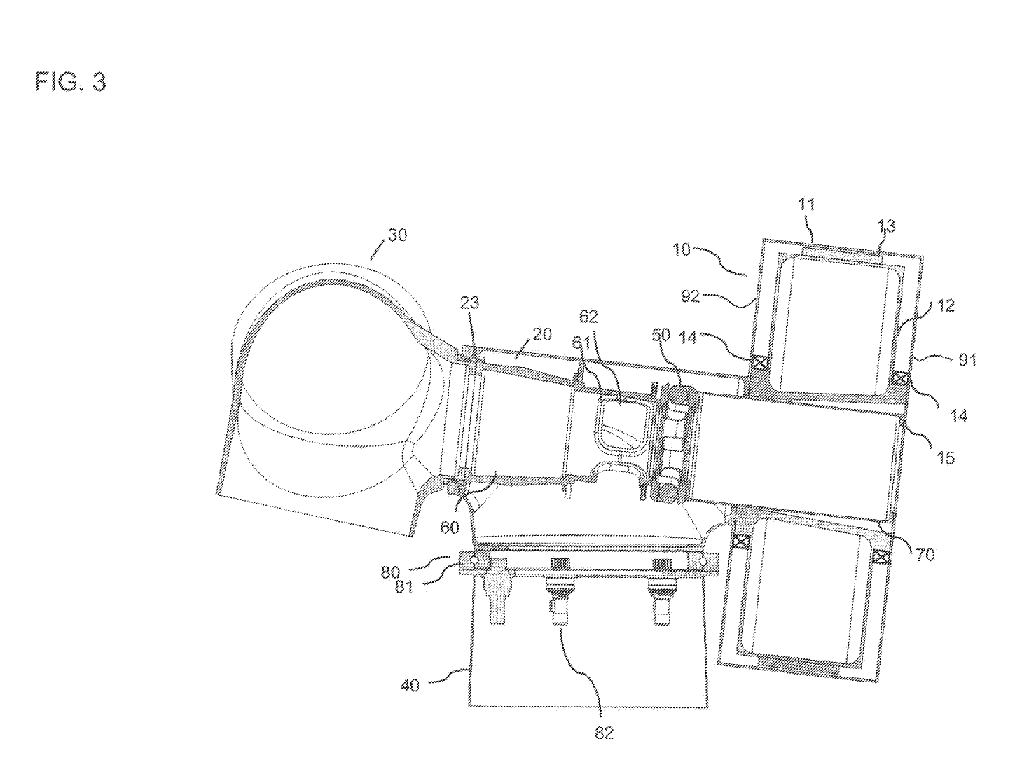

As a result of the tubular shape, such an embodiment is very well suited for the use of torque bearings. Various examples for the embodiment of the bearings 21, 22, 23 are illustrated in the figures. FIG. 1 shows a directly driven wind turbine, in which the bearings 21 of the rotor shaft 60 are provided as single-row tapered roller bearings; FIG. 2 shows a directly driven wind turbine in which the bearings 22 of the rotor shaft 60 are provided as self-aligning roller bearings; FIG. 3 shows a directly driven wind turbine in which the bearing 23 of the rotor shaft 60 is provided as a torque bearing.

The generator 10 is preferably provided as a permanent magnetic synchronous generator, and the generator stator 12 is provided with a stator winding 13. Permanent magnets (not shown) are fastened in the inner region of the generator rotor 11 which faces the stator winding 13; the permanent magnets are generally only a few 1 mm to a few 10 mm in thickness.

The generator shaft 70, as described above, is substantially indirectly borne by the machine frame 20 via the generator stator 12, the bearings 14 and the generator rotor 11, wherein the generator shaft 70 together with the generator stator 12 and the generator rotor 11 can follow bending movements of the machine frame 20 without the air gap between the exciter of the generator rotor 11 and the stator windings 13 being changed.

Using the described features, a directly driven wind turbine with a rated power of several MW, for example, can be produced, wherein the wind turbine has an advantageous ratio of tower head mass to rated power.

By providing a generator having an external-rotor configuration, relatively high generator powers can be realized in comparison to an internal-rotor generator given virtually the same weight, which results in a cost advantage. The improved distribution of the tower head mass with respect to drive train configurations in which the generator is arranged on the hub side results in lower material stress and, as a result, in reduced complexity in terms of maintenance and increased availability of the wind turbine. A further advantage of the invention results from the high degree of modularity of the drive train configuration. The generator which is mounted in itself can be removed completely from the turbine once the connection interfaces between the machine frame and the generator stator and the coupling arrangement between the rotor shaft and the generator shaft and the cable and cooling lines etc. have been detached. While in the case of designs in which the generator is arranged between the rotor hub and the tower, the rotor comprising the rotor hub and the rotor blades also needs to be disassembled in order to remove the generator, in the wind turbine described here it is possible for the components to be maintained independently of one another. This results in particular in the case of offshore wind turbines in a cost advantage which is not inconsiderable since in each case only one jack-up rig or jack-up barge is required for maintenance work. Owing to the at least one radial in the rotor shaft, it is possible to access the rotor hub for maintenance work through the machine room from the inside, which results in improved safety of the maintenance and service personnel in comparison with access to the rotor hub from the outside.

It is understood that the foregoing description is that of the preferred embodiments of the invention and that various changes and modifications may be made thereto without departing from the spirit and scope of the invention as defined in the appended claims.

What is claimed is:

1. A wind turbine comprising:
a machine frame having a first side and a second side;
a rotor disposed on said first side of said machine frame;
a generator disposed on said second side of said machine frame;
a rotor shaft;
a generator shaft;
a coupling arrangement disposed between said rotor shaft and said generator shaft;
said generator and said rotor being gearlessly coupled to one another via said rotor shaft, said generator shaft and said coupling arrangement; and,
said generator having an external rotor configuration.

2. The wind turbine of claim 1 wherein said coupling arrangement is configured to transmit rotary movements of said rotor shaft to said generator shaft and is further configured to at least partially decouple said generator shaft from bending movements of said rotor shaft.

3. The wind turbine of claim 1, wherein:
said generator has a front side and a rear side which faces away from said rotor; and,
said generator shaft is fastened to said rear side of said generator via a connection.

4. The wind turbine of claim 3, wherein said connection is one of a flange connection and a welded joint.

5. The wind turbine of claim 3 wherein:
said generator shaft is directly mounted to said coupling arrangement and to said connection on said rear side of said generator and extends between said coupling arrangement and said connection from said coupling arrangement through said generator as far as said rear side of said generator.

6. The wind turbine of claim 3, wherein said generator shaft is substantially supported by said connection on said rear side of said generator.

7. The wind turbine of claim 1, wherein said generator shaft is configured as a hollow shaft.

8. The wind turbine of claim 1, wherein said generator shaft has a wall thickness and a diameter; said diameter and said wall thickness having a ratio of at least 10:1.

9. The wind turbine of claim 1, wherein said generator is supported exclusively by said machine frame.

10. The wind turbine of claim 1, wherein said generator is connected exclusively by said machine frame via a flange connection.

11. The wind turbine of claim 1 further comprising:
said generator including a generator stator and a generator rotor;
a plurality of bearings arranged between said generator stator and said generator rotor; and,
said generator rotor being rotatably mounted about said generator stator via said bearings.

12. The wind turbine of claim 1, further comprising:
a generator stator having an outer wall;
a generator rotor having an inner wall and defining a rotational axis; and,
a first and a second bearing arranged between said outer wall of said generator stator and said inner wall of said generator rotor in such a manner that said generator stator is arranged between said first and said second bearing with respect to said rotational axis of said generator rotor.

13. The wind turbine of claim 12, wherein:
said first and said second bearing each have a respective inner bearing ring fastened to said generator stator and an outer bearing ring fastened to said generator rotor;
said coupling arrangement having a generator side facing said generator; and,
said first and said second bearing being configured to be the only bearings disposed on said generator side of said coupling arrangement.

14. The wind turbine of claim 11, wherein said generator is configured as a permanent magnet synchronous generator.

15. The wind turbine of claim 1,
said generator having a rear side facing away from said coupling arrangement;
a connection connecting said generator shaft to said rear side of said generator;
said generator including a generator stator having stator windings and a generator rotor having excitation elements;
first and second bearings interposed between said generator and said generator rotor;
a machine frame; and,
said generator shaft being supported essentially by said connection via said generator stator, said bearings and said generator rotor by said machine frame;
said stator windings and said excitation elements conjointly defining an air gap therebetween; and,
said generator shaft being configured to follow bending movements of said machine frame together with said generator rotor and said generator stator without said air gap being changed.

16. The wind turbine of claim 15, wherein:
said generator rotor has a rear side facing away from said machine frame, lateral surface side, and a front side facing said machine frame and defining an opening; and,
said generator rotor is configured to surround said generator stator on all sides apart from said opening.

17. The wind turbine of claim 16, wherein said opening has a diameter which is less than or equal to an outer diameter of said bearings.

18. The wind turbine of claim 1, wherein the generator is mounted in itself and once the coupling arrangement and connection interfaces between the machine frame and the generator stator have been detached, can be removed completely from the wind turbine.
